(19) United States
(12) Patent Application Publication
(10) Pub. No.: US 2012/0283013 A1
(43) Pub. Date: Nov. 8, 2012

(54) METHODS, COMPUTER PROGRAM PRODUCTS, AND SYSTEMS FOR AWARDING ITEMS IN A MULTIPLAYER ONLINE GAME

(75) Inventor: Yao Qi Guo, Qingdao (CN)

(73) Assignee: EVONY, LLC, New York, NY (US)

(21) Appl. No.: 13/414,208

(22) Filed: Mar. 7, 2012

Related U.S. Application Data
(63) Continuation of application No. PCT/US2010/048111, filed on Sep. 8, 2010.
(60) Provisional application No. 61/240,313, filed on Sep. 8, 2009.

(51) Int. Cl. A63F 13/12

(52) U.S. Cl. 463/31

(57) ABSTRACT

One aspect of the invention provides a method of awarding items in a multiplayer online game. The method includes: presenting a primary award interface to a first user, the award interface configured to implement a primary award algorithm that determines whether the first user will receive an item and, if so, informs the first user of the award; and informing other users of the award to the first user. Another aspect of the invention provides a system awarding items in a multiplayer online game. The system includes a presentation module configured to present an award interface to a first user, the award interface configured implement a primary award algorithm that determines whether the first user will receive an item and, if so, informs the first user of the award; and a notification module configured to inform other users of the award to the first user.

### CROSS-REFERENCE TO RELATED APPLICATIONS

This application is a continuation application of International Application No. PCT/US2010/048111, filed Sep. 8, 2010; which claims priority to U.S. Provisional Patent Application Ser. No. 61/240,313, filed Sep. 8, 2009. The entire contents of this application are hereby incorporated by reference herein.

### BACKGROUND

The ubiquity of the Internet and increasing bandwidth and computing power allow for increasingly collaborative online gaming experiences. For example, massively multiplayer online games (MMOGs) allow hundreds or thousands of users to interact in a persistent world.

A number of online games, such the EVONY® game available from Evony, LLC of Wilmington, Del. operate on a “freemium” business model in which the game is free to play, but users can purchase enhancements such as additional weapons and other resources.

According, there is a need for methods, computer program products, and systems for awarding items that will incentivize users to purchase enhancements.

### SUMMARY OF THE INVENTION

One aspect of the invention provides a method of awarding items in a multiplayer online game. The method includes: presenting a primary award interface to a first user, the award interface configured to implement a primary award algorithm that determines whether the first user will receive an item and, if so, informs the first user of the award; and informing other users of the award to the first user.

This aspect of the invention can have a variety of embodiments. The item can be randomly selected, semi-randomly selected, selected by the first user, and/or selected through a sub-game.

The primary award interface can displays a plurality of items, sequentially highlight one or more of the plurality of items, and indicate which item will be awarded to the first user.

The step of informing other users of the award to the first user can include sending a message to the other users. The message can be displayed on a further interface for the multiplayer online game. The message can be transmitted electronically to the other users. The message can be transmitted electronically through one or more selected from the group consisting of: electronic mail, a web log, a microblog, and Short Message Service (SMS).

The step of informing other users of the award to the first user can include aggregating information about the award with information about other awards.

The method can include implementing a secondary award algorithm to award one or more further items to the users. The secondary award algorithm can award items to one or more users that utilized the award interface over a period of time. The items and users can be randomly selected. The items and users can be semi-randomly selected. The users can be selected based on a number of utilizations of the primary award algorithm over the period of time.

Another aspect of the invention provides a computer program product comprising computer-usable medium having control logic stored therein for causing a computer to implement a method of awarding items in a multiplayer online game. The control logic includes: first computer readable program code for causing the computer to present a primary award interface to a first user, the award interface configured to implement a primary award algorithm that determines whether the first user will receive an item and, if so, informs the first user of the award; and second computer readable program code for causing the computer to inform other users of the award to the first user.

The aspect of the invention can have a variety of embodiments. The control logic can further include third computer readable program code for implementing a secondary award algorithm to award one or more further items to the users. The computer-usable medium can be non-transitory and tangible.

Another aspect of the invention provides a system awarding items in a multiplayer online game. The system includes a presentation module configured to present an award interface to a first user, the award interface configured implement a primary award algorithm that determines whether the first user will receive an item and, if so, informs the first user of the award; and a notification module configured to inform other users of the award to the first user.

### FIGURES

For a fuller understanding of the nature and desired objects of the present invention, reference is made to the following detailed description taken in conjunction with the figure wherein:

FIG. 1 depicts an exemplary game architecture suitable for a massively multiplayer online game;

FIG. 2 depicts an exemplary user interface for awarding an item in the EVONY® MMOG;

FIG. 3 depicts a “billboard” user interface according one embodiment of the invention;

FIG. 4 depicts a user interface providing secondary award criteria according one embodiment of the invention; and

FIG. 5 depicts a method of awarding items in a multiplayer online game according one embodiment of the invention.

### DEFINITIONS

The instant invention is most clearly understood with reference to the following definitions:

As used in the specification and claims, the singular form “a,” “an,” and “the” include plural references unless the context clearly dictates otherwise.

A computer-usable medium shall be understood to mean any article of manufacture that contains data that can be read by a computer or a carrier wave signal carrying data that can be read by a computer. Such computer-usable media includes, but is not limited to, magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; paper media, such as punched cards and paper tape; or on carrier wave signal received through a network, wireless network or modem, including radio-frequency signals and infrared signals. Such computer-readable medium can be non-transitory and/or tangible.

The term “random” shall be understood to describe a process of selection having no definite aim or purpose. Such a definition encompasses, but is not limited to processes of selection in which each item of a set has a substantially equal probability of being chosen.

The term “semi-random” shall be understood to describe a process of selection having no definite aim or purpose, but wherein certain items in a set have non-equal probabilities of selection. Such a process can be achieved, for example, by removing one or more items from a set or be increasing the number of certain items within a set.

### DESCRIPTION OF THE INVENTION

Aspects of the invention provide methods, computer program products, and systems that randomly select an item and award it to a user. The award can then be advertised on a bulletin board where further secondary prizes are awarded automatically in the interest of spurring incentive to customers to purchase. Aspects of the invention are particularly applicable in the video game field.

### Game Architecture

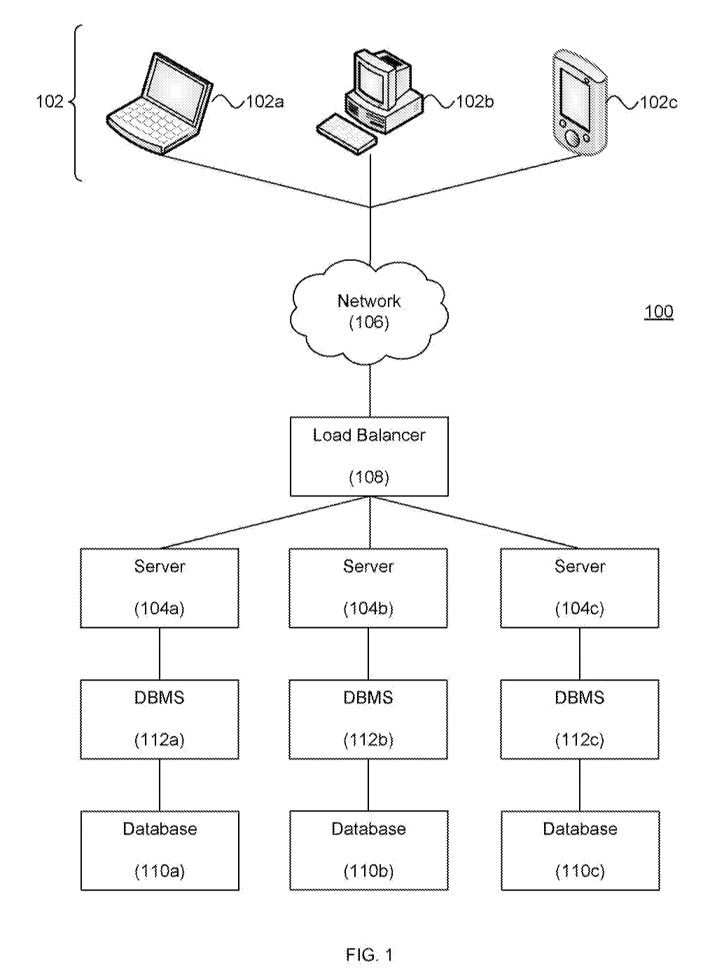

Aspects of the invention can be applied to a variety of games, particularly online games such as MMOGs. An exemplary game architecture 100 suitable for an MMOG is depicted in FIG. 1.

At the highest level, architecture 100 includes clients 102 and servers 104 connected via a network 106 such as the Internet.

Clients 102 can include laptop computers 102a, desktop computers 102b, handheld devices 102c (e.g., a tablet computer, personal digital assistant, cellular telephone, smart phone), and the like now known and later developed. Clients 102 can include display(s) appreciated by those of ordinary skill in the pertinent art. The displays can include any of a number of devices known to those skilled in the art for displaying images responsive to outputs signals from the clients 102. Such devices include, but are not limited to, cathode ray tubes (CRTs), liquid crystal displays (LCDs), plasma screens and the like. Although a simplified diagram is illustrated in FIG. 1, such illustration shall not be construed as limiting the present invention to the illustrated embodiment. It should be recognized that the signals output from the clients 104 can originate from any of a number of devices including PCI or AGP video boards or cards mounted within the housing of the clients 102 that are operably coupled to the microprocessors and the displays thereof.

In some embodiments, clients 102 include one or more video game consoles now known or later developed. Such consoles can include Ethernet port to connect to server 104 via network 106, video output ports for displaying images on a display device such as a television, input devices such as compact disc (CD) or digital video disc (DVD) drives to load games, local memory to save data, and input ports to receive input from controllers or keyboards. Examples of suitable video game consoles include the NINTENDO® WII@ console available from Nintendo of America Inc. of Redmond, Wash.; the SONY® PLAYSTATION® console available from Kabushiki Kaisha Sony Corporation of Tokyo, Japan; the MICROSOFT® XBOX® console available from Microsoft Corporation of Redmond, Wash.; and the like.

Clients 102 can access server 104 through proprietary or commercially-available software. For example, clients 102 can utilize an Internet browser to access a Hypertext Transfer Protocol (HTTP) interface provided by server 104. Suitable Internet browsers include the INTERNET EXPLORER® browser available from Microsoft Corporation of Redmond, Wash.; the FIREFOX® browser available from the Mozilla Foundation of Mountain View, Calif.; the OPERA® browser available from Opera Software AS of Oslo, Norway; or the CHROME™ browser available from Google Inc. of Menlo Park, Calif. Alternatively, clients 102 can interact with system 104 via specially-programmed software such as an application installed on clients 102. In still another embodiment, the client 102 and server 104 can communicate through a multimedia platform such as ADOBE® FLASH®, available from Adobe Systems Incorporated of San Jose, Calif.

In order to enable scaling and reduce lag, MMOGs often utilize multiple servers 104 as depicted in FIG. 1. Each server 104 can implement one or more instances of the MMOG, which are known as “shards.” Thus, a first client 102a and a second client 102b can both play on the same shard implemented on a first server 104a. Clients 102a and 102b can interact with each other, but will have limited, if any, interaction with a third client 102c playing on another shard implemented on the second server 104b. Advantageously, first server 104a does not need to be concerned with the activities of the third client 104b.

System 100 can include a load balancer module 108 to route traffic between clients 102 and servers 104. Various schemes can be used as are familiar to those of skill in the art. For example, when new clients 102 access system 100, load balancer 108 can direct client 102 to a newly opened server 104c until the server 104c reaches capacity. At that point, load balancer 108 can direct traffic to yet another server 104. Requests from existing clients 102 can be routed to the server 104 that the client 102 previously accessed.

All traffic need not flow through load balancer 108. For example, traffic can flow directly between clients 102 and servers 104 (via network 106) once initial contact is made between clients 102 and servers 104 as mediated by the load balancer 108.

Server 104 can communicate with a database 110 through a database management system (DBMS) 112. A DBMS 112 is imposed upon the data in database 110 to form a logical and structured organization of the data. A DBMS 110 lies between the physical storage of data and the users and handles the interaction between the two. Examples of DBMSes include DB2® and INFORMIX® DBMSes both available from IBM Corp. of Armonk, N.Y.; MICROSOFT JET® and MICROSOFT SQL SERVER® DBMSes both available from the Microsoft Corporation of Redmond, Wash.; MYSQL® DBMS available from the MySQL Ltd. Co. of Stockholm, Sweden; ORACLE® DBMS available from Oracle Int'l Corp of Redwood City, Calif.; and SYBASE® DBMS available from Sybase, Inc. of Dublin, Calif.

In some games, a plurality of users each control one or more entities, which may vary depending on the genre of the game. For example, in the EVONY® MMOG, available from Evony, LLC of Wilmington, Del., users control cities. Other exemplary entities include nations, tribes, towns, villages, and the like. Users can utilize their entities to produce resources such as currency, wood, metal, food, and the like. Users can also interact with other entities to wage war and peace. For example, entities can marshal armies and obtain weapons that are used in virtual battles.

### Systems, Methods, and Computer Program Products for Awarding Items

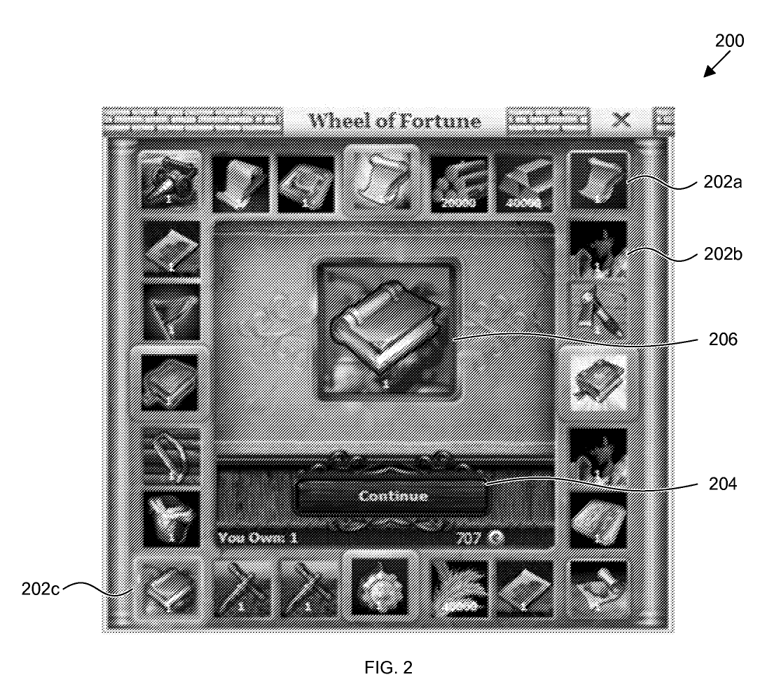

Referring now to FIG. 2, an exemplary user interface 200 for awarding an item in the EVONY® MMOG is provided. The user interface 200 includes a plurality of images 202 of items that can be awarded. The user can activate the user interface by clicking a button 204 or other GUI widgets such as a hyperlink and the like.

Once activated, user interface 200 simulates a roulette wheel, slot machine, or other game of chance. In general, one of the depicted items is randomly or semi-randomly selected. The user interface 200 can represent this random or semi-random selection in a variety of ways. For example, one or more images 202c can be sequentially highlighted. Additionally or alternatively, one or more images 200 can be sequentially displayed in a prominent location 206. In some embodiments, the movement of the highlight is substantially circuitous. In other embodiments, a random sequence generator is used to generate a random sequence of highlights. Accordingly, each utilization of the user interface 200 can, in some embodiments, be referred to as a “spin.”

Eventually, an item is awarded and can be highlighted and/or depicted prominently. This item is added to the user's inventory.

One of skill in the art will readily appreciate that the user interface 200 depicted is an exemplary embodiment and that other user interfaces can be employed. For example, images 202 need not be arranged in a square or a rectangle as depicted in FIG. 2. Rather, images 202 can be arranged in a circle, triangle, pentagon, hexagon, n-gon, or other shape.

Moreover, user interface 200 need not be a graphical user interface as depicted in FIG. 2. Rather, user interface can be a textual user interface, which can be particularly advantageous for implementation over a cellular telephone infrastructure.

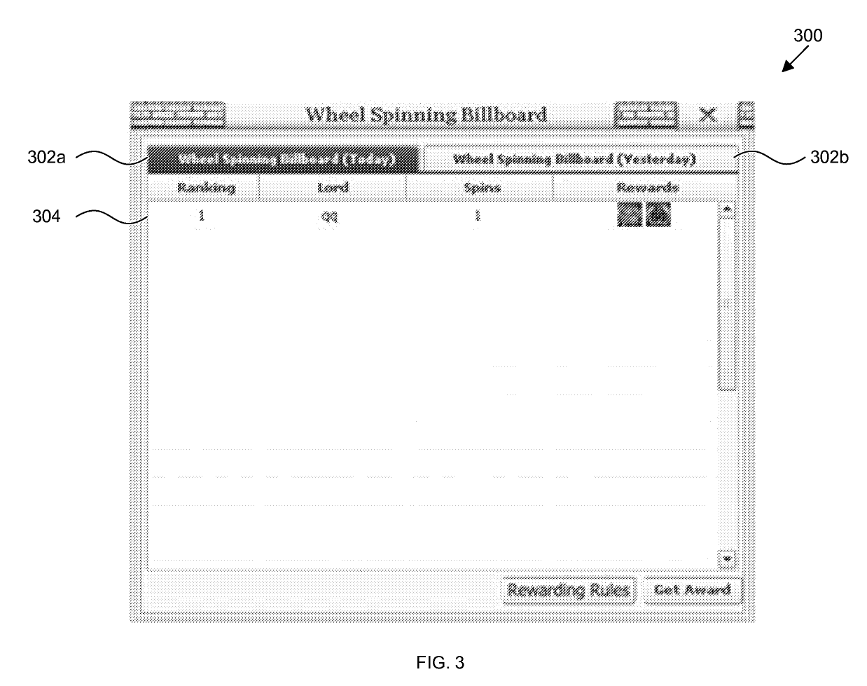

Referring now to FIG. 3, another user interface 300 serves as a “billboard” that provides information about items awarded in user interface 200. By providing information regarding awarded items, user interest is increased.

User interface 300 can include one or more tabs 302 or other GUI widget to allow for viewing of award data for one or more time periods (e.g., hours, days, weeks, months, years, and the like). For each time period, data regarding the number of spins and/or items awarded can be provided for one or more users. Users can be ranked by the number of spins to further incentivize users to utilize the award interface 200. The items awarded can be represented textually or graphically (as depicted in FIG. 3).

Users can access rules regarding secondary awards by clicking a button 306 or other GUI element. In some embodiments, users must access interface 300 and click a button 308 or other GUI element to receive the secondary award.

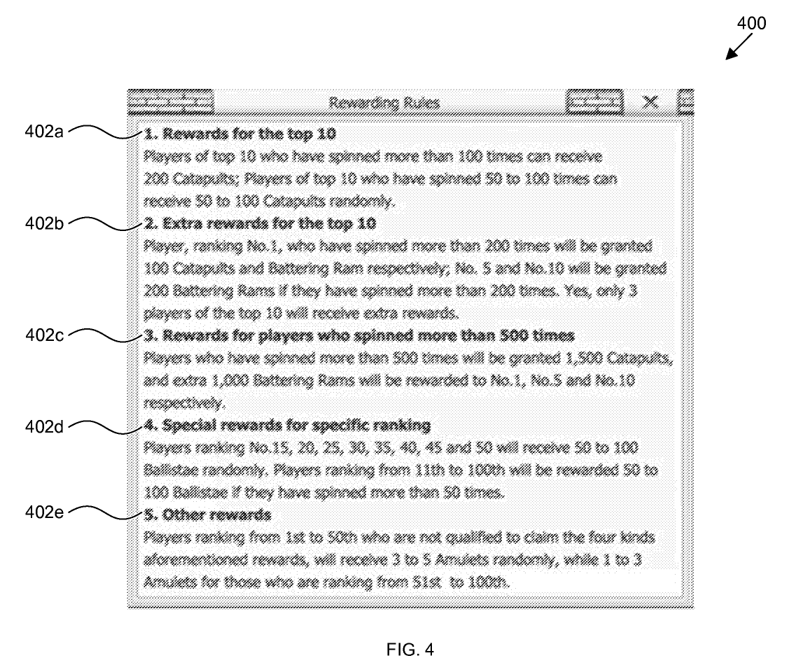

Referring now to FIG. 4, another user interface 400 is provided. User interface 400 can in some embodiments be accessed through button 306. As depicted in FIG. 4, secondary awards can be given to users meeting one or more criteria 402. These criteria 402 can be explicitly provided to users so that users clearly understand the criteria for receiving secondary awards can are motivated to strategize accordingly. Additionally or alternatively, all or a portion of secondary awards can be given randomly or semi-randomly to alert casual users of existence of the same.

A number of exemplary criteria 402 are depicted in FIG. 4. For example, secondary awards can be provided to users having the top n spins within a time period (n being a positive integer), users spinning more than m times within a time period (m being a positive integer), users having particular rankings, and the like. The criteria 402 can be further nuanced. For example, criterion 402a provides secondary awards to the top 10 users, but conditions the magnitude of the secondary awards based on the number of spins by each individual user.

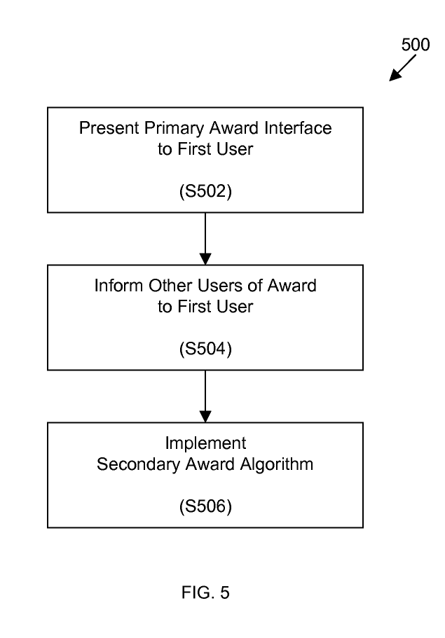

Referring now to FIG. 5, further aspects of the invention are described in the context of method 500.

In step S502, a primary award interface is provided to a first user. The primary award interface can, in some embodiments, be a user interface 200 that displays a plurality of items, sequentially highlights one or more of the plurality of items, and indicates which item will be awarded to the first user as described herein in the context of FIG. 2. The primary award interface is configured to implement a primary award algorithm that determines whether the first user will receive an item and, if so, informs the first user of the award.

As discussed herein in the context of FIG. 2, the primary award algorithm can select an item randomly or semi-randomly. For example, if a primary award interface 200 includes 20 items, each item can be assigned an integer between 1 and 20 and a random number generator can be used to generate a number between 1 and 20.

In some embodiments, the primary award algorithm is semi-random. For example, items that would be particularly advantageous to the user can be more or less likely to be awarded by the algorithm. This can be accomplished by modulating the probabilities of particular items within a set or by modulating the frequency of items within a set (e.g., including two instances of a sword).

In other embodiments, the user is allowed to simply select an item from a plurality of items.

In still other embodiments, the user can be awarded an item based on performance in a sub-game (i.e., a game within the larger game). For example, the user can be required to hit one or more targets with a simulated bow-and-arrow to receive items.

In step S504, other users are notified of the award to first user.

A variety of techniques can be utilized to inform other users of the award to the first user. In one embodiment, users can view a billboard as depicted FIG. 3. In other embodiments, users can be informed by textual, audio, and/or visual alerts while playing a game. For example, an alerts may “pop-up” within the game or the game interface can include a running “ticker” or “crawler” that continuous streams information regarding awards across the screen. In still another embodiment, users can receive electronic messages regarding awards. Such messages can be actively sent to one or more user users (e.g., through electronic mail, Short Message Service (SMS) messages, and the like) or can be passively posted to an RSS feed, a web log (also known as a “blog”), a microblog (e.g., the TWITTER® service available from Twitter, Inc. of San Francisco, Calif.), and the like.

Other users can be alerted regarding each individual award. Alternatively, information about awards can be aggregated and presented to the other users in a single message or alert. Moreover, the set of awards can be filtered such that users do not receive notifications of common items, thereby minimizing the number of messages sent.

In step S206, a secondary award algorithm is implemented to award one or more further items to the users. The secondary award algorithm can be limited to users that utilized the primary award interface over a time period, thereby encouraging regular use of the primary award interface. The secondary award algorithm can award items in the same or similar manner as the primary award algorithms discussed herein. For example, the secondary award item can be randomly or semi-randomly selected. Additionally or alternatively, users and/or items can be selected based on the number of utilizations of the primary award interface over a period of time.

Implementation in Hardware and/or Software

The systems and methods herein can be implemented on general-purpose or specially-programmed hardware or software. For example, the methods can be implemented by a computer-usable medium. The computer-usable medium can be non-transitory and/or tangible. For example, the computer-usable medium can be volatile memory (e.g., random access memory and the like) or non-volatile memory (e.g., read-only memory, hard disks, floppy discs, magnetic tape, optical discs, paper table, punch cards, and the like).

The interfaces 200, 300, 400 and method 500 described herein can be implemented on one or more servers 104 and the user interfaces can be displayed on clients 102. Information on the users can be obtained from databases 110 via DBMSes 112. Likewise, information regarding items awards can be stored on databases 110 via DBMSes 112.

### INCORPORATION BY REFERENCE

All patents, published patent applications, and other references disclosed herein are hereby expressly incorporated by reference in their entireties by reference.

### Equivalents

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, computers, clients, servers and the like) shown as distinct for purposes of illustration may be incorporated within other functional elements, separated in different hardware or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

1. A method of awarding items in a multiplayer online game, the method comprising:
presenting a primary award interface to a first user, the award interface configured to implement a primary award algorithm that determines whether the first user will receive an item and, if so, informs the first user of the award; and
informing other users of the award to the first user.

2. The method of claim 1, wherein the item is randomly selected.

3. The method of claim 1, wherein the item is semi-randomly selected.

4. The method of claim 1, wherein the item is selected by the first user.

5. The method of claim 1, wherein the item is selected through a sub-game.

6. The method of claim 1, wherein the primary award interface:
displays a plurality of items;
sequentially highlights one or more of the plurality of items; and
indicates which item will be awarded to the first user.

7. The method of claim 1, wherein the step of informing other users of the award to the first user includes sending a message to the other users.

8. The method of claim 7, wherein the message is displayed on a further interface for the multiplayer online game.

9. The method of claim 7, wherein the message is transmitted electronically to the other users.

10. The method of claim 9, wherein the message is transmitted electronically through one or more selected from the group consisting of: electronic mail, a web log, a microblog, and Short Message Service (SMS).

11. The method of claim 1, wherein the step of informing other users of the award to the first user includes aggregating information about the award with information about other awards.

12. The method of claim 1, further comprising:
implementing a secondary award algorithm to award one or more further items to the users.

13. The method of claim 12, wherein the secondary award algorithm awards items to one or more users that utilized the award interface over a period of time.

14. The method of claim 13, wherein the items and users are randomly selected.

15. The method of claim 13, wherein the items and users are semi-randomly selected.

16. The method of claim 13, wherein the users are selected based on a number of utilizations of the primary award algorithm over the period of time.

17. A computer program product comprising computer-usable medium having control logic stored therein for causing a computer to implement a method of awarding items in a multiplayer online game, the control logic comprising:
first computer readable program code for causing the computer to present a primary award interface to a first user, the award interface configured to implement a primary award algorithm that determines whether the first user will receive an item and, if so, informs the first user of the award; and
second computer readable program code for causing the computer to inform other users of the award to the first user.

18. The computer program product of claim 17, wherein the control logic further comprises:
third computer readable program code for implementing a secondary award algorithm to award one or more further items to the users.

19. The computer-program product of claim 17, wherein the computer-usable medium is non-transitory and tangible.

20. A system awarding items in a multiplayer online game, the system comprising:
a presentation module configured to present an award interface to a first user, the award interface configured implement a primary award algorithm that determines whether the first user will receive an item and, if so, informs the first user of the award; and
a notification module configured to inform other users of the award to the first user.
